(19) United States
(12) Patent Application Publication
(10) Pub. No.: US 2011/0167079 A1
(43) Pub. Date: Jul. 7, 2011

(54) FRAMEWORK FOR TRACK-BASED MOBILE APPLICATIONS

(75) Inventors: Maya Haridasan, San Jose, CA (US); Iqbal Mohomed, Mountain View, CA (US); Douglas Brian Terry, San Carlos, CA (US); Ganesh Ananthanarayanan, Berkeley, CA (US); Chandramohan A. Thekkath, Palo Alto, CA (US)

(73) Assignee: Microsoft Corporation, Redmond, WA (US)

(21) Appl. No.: 12/683,449

(22) Filed: Jan. 7, 2010

(51) Int. Cl. G06F 17/30; G06F 15/16

(52) U.S. Cl. 707/769; 709/203; 707/E17.014

(57) ABSTRACT

Tracks associated with a first user are identified by a computing device. Each track may include location identifiers. The identified tracks are clustered to generate a composite track for the first user by the computing device. At least one track that is similar to the composite track is identified by the computing device. The at least one track may be associated with a user other than the first user. Information related to the identified at least one track that is similar to the composite track is provided by the computing device through a network.

### BACKGROUND

Targeted advertising is a popular and efficient technique for providing advertisements. One method of targeted advertising is to target advertisements based on the content of a publication. For example, a store specializing in music may have their advertisements displayed in a magazine or on web pages that are music related or known to be visited by people who buy music.

Another technique for targeted advertisement is to target advertisements based on a location associated with the user. The location of a user may be determined by an IP (Internet Protocol) address associated with the user, or through a global positioning system or other location aware technology associated with the user. For example, a user of a cellular phone may receive advertisements for a coffee shop when it is determined that the user is near the coffee shop. However, targeting advertisements based on a user's current location may not be particularly effective because the user's current location may not be an accurate identifier of the user's true preferences. Continuing the example above, the user may not like coffee, or the user may be near the coffee shop at a time when the user does not typically drink coffee.

### SUMMARY

The locations of a user over time are monitored by a mobile device such as a cellular phone. The monitored locations are organized into tracks that describe a path or route that the user took over a period of time. The tracks associated with the user, and tracks associated with other users, are collected and stored by a track server. The stored tracks may be analyzed by the track server to identify similar tracks and to identify users having similar tracks with one another. The track server may further support an application programming interface that allows developers to create applications that use tracks. Examples of such applications may include applications that recommend carpool arrangements to users (e.g., based on their commutes), applications that recommend walks or trails to users to take (e.g., based on the tracks of their friends), and applications that provide targeted advertisements or business recommendations (e.g., based on the tracks of a user).

In an implementation, tracks associated with a first user are identified by a computing device. Each track may include location identifiers. The identified tracks are clustered to generate a composite track for the first user by the computing device. At least one track that is similar to the composite track is identified by the computing device. The at least one track may be associated with a user other than the first user. Information related to the identified at least one track that is similar to the composite track is provided by the computing device through a network.

Implementations may include some or all of the following features. Each track may represent a commute. The identified at least one track may have associated advertisements, and providing information related to the at least one track that is similar to the composite track may include providing one or more of the associated advertisements to the first user. The clustering may be k-means clustering. Businesses associated with the at least one identified track may be identified, and providing information related to the at least one identified track that is similar to the composite track may include providing identifiers of one or more of the identified businesses to the first user. Each track may have associated metadata, and providing information related to the at least one track that is similar to the composite track may include providing the metadata associated with the at least one track.

Identifying at least one track that is similar to the composite track may include defining an area around each location identifier of the composite track, selecting a track from a plurality of tracks that is associated with a user other than the first user, determining the percentage of location identifiers of the selected track that is within one of the defined areas, and identifying the selected track as a similar track if the percentage is greater than a threshold percentage. The defined areas may be circles and defining an area around each location identifier may include, for each location identifier of the composite track, determining a distance between the location identifier and a previous location identifier, determining a radius for a defined area based on the determined distance, and defining an area around the location identifier having the determined radius.

Identifying at least one track that is similar to the composite track may include defining a path through the location identifiers of the composite track, selecting a track from a plurality of tracks that is associated with a user other than the first user, determining the percentage of location identifiers of the selected track that is within the defined path, and identifying the selected track as a similar track if the percentage is greater than a threshold percentage. The path may have an associated width at each of the location identifiers of the composite track, and defining a path through the location identifiers of the composite track may include, for each location identifier of the composite track, determining a distance between the location identifier and a previous location identifier, and determining the width for the path at the location identifier based on the determined distance. Determining the width for the path at the location identifier based on the determined distance may include determining the width to be equal to the determined distance.

In an implementation, a query is received from a first user through a network by a computing device. One or more tracks that are responsive to the query are identified by the computing device. Each track may include location identifiers and may represent a route taken by a user other than the first user. At least one of the identified tracks is presented to the first user by the computing device through the network.

Implementations may include some or all of the following features. The first user may have an associated location identifier and identifying one or more tracks that are responsive to the query may include identifying one or more tracks that have a location identifier that identifies a location that is geographically near the location identified by the location identifier associated with the first user. The query may have an associated temporal identifier and each track may have an associated temporal identifier, and identifying one or more tracks that are responsive to the query may include identifying one or more tracks that have associated temporal identifiers that are close to the temporal identifier associated with the query. Each track may have associated metadata, and identifying one or more tracks that are responsive to the query may include identifying one or more tracks that have metadata that matches the query.

This summary is provided to introduce a selection of concepts in a simplified form that is further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an example environment for the generation and use of tracks;

FIG. 2 is a block diagram of an implementation of an example track server;

FIG. 3 is an illustration of two example tracks;

FIG. 4 is an illustration for an example process for determining similar tracks using defined areas;

FIG. 5 is an illustration for an example process for determining similar tracks using a path;

FIG. 6 is an operational flow of an implementation of a method for identifying a similar track using a cluster and providing information related to the similar track;

FIG. 7 is an operational flow of an implementation of a method for identifying similar tracks using defined areas;

FIG. 8 is an operational flow of an implementation of a method for identifying similar tracks using a path;

FIG. 9 is an operational flow of an implementation of a method for identifying one or more tracks responsive to a query; and

FIG. 10 is a block diagram of a computing system environment according to an implementation of the present system.

### DETAILED DESCRIPTION

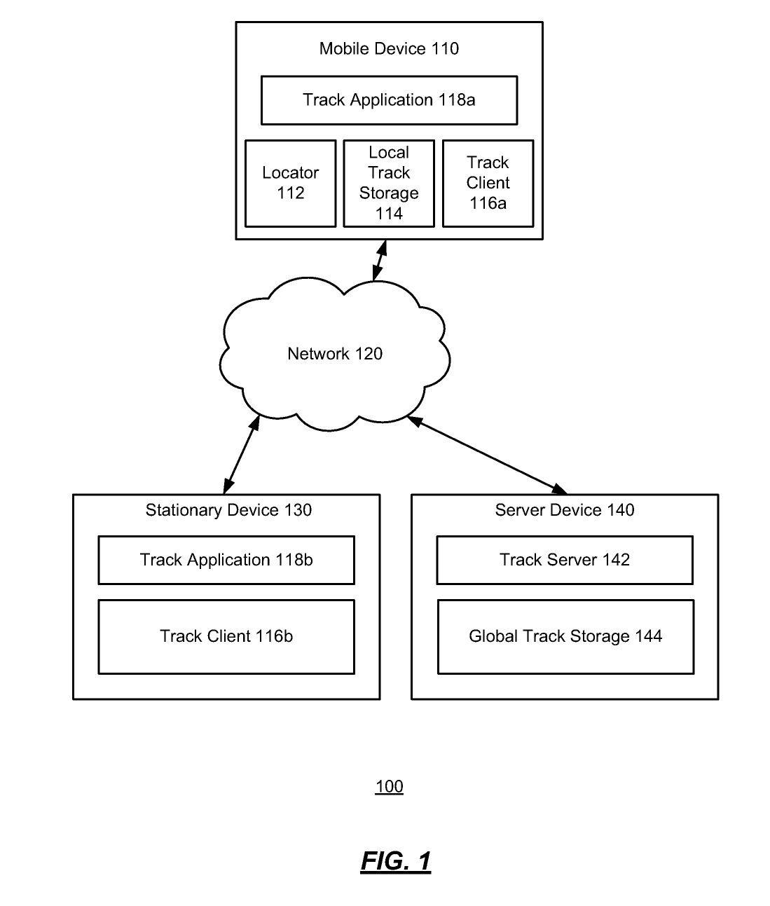

FIG. 1 is an illustration of an example environment 100 for the generation and use of tracks. In some implementations, a track may be a collection of location identifiers along with temporal identifiers that indicate times during which some of all of the location identifiers were determined. A track may also be associated with a user. The track may purport to represent a path or route that the associated user took. In some implementations, the location identifiers making up the track are collected by a mobile device 110 using a global positioning system (GPS).

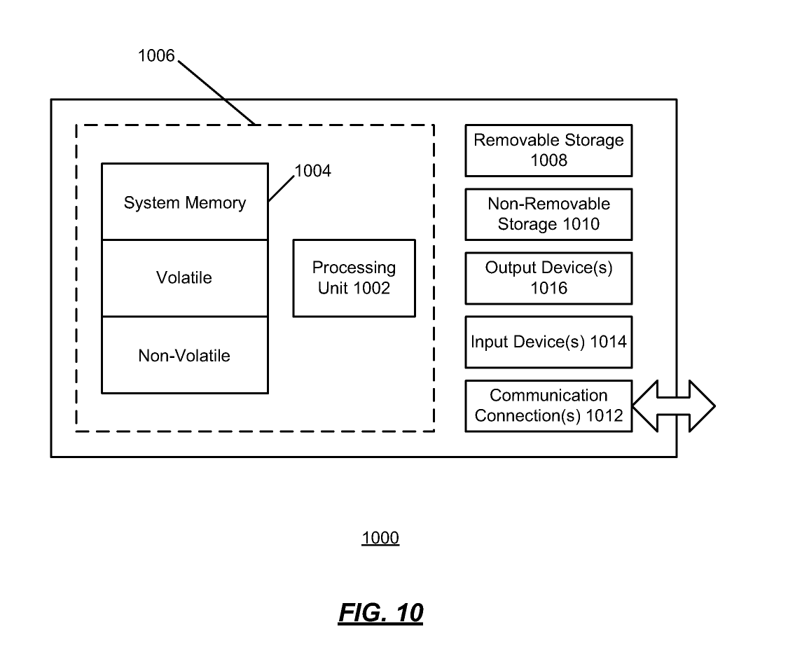

As described above, the environment 100 may include a mobile device 110. The mobile device 110 may include a variety of mobile computer devices including, but not limited to, cellular phones, personal digital assistants, video game devices, audio and video players, watches, dongles, laptops, or any other type of computer device. The mobile device 110 may be any computer device that can be with the user while the user travels. Thus, the mobile device 110 may be a cellular phone that the user carries on their person, or a computer installed in a car that the user drives in. An example computer device may comprise the computing device 1000 illustrated in FIG. 10, for example.

As illustrated in FIG. 1, the mobile device 110 includes a locator 112. The locator 112 may be a component of the mobile device 110 that determines the location of the mobile device 110. In some implementations, the locator 112 may be a GPS device. Other types of devices may also be used. For example, the locator 112 may determine the location of the mobile device 110 using cellular phone signal information (e.g., distance from cellular towers) or Wi-Fi signal information (e.g., distance from Wi-Fi hotspots having a known location). In some implementations, the locator 112 may not be located at the mobile device 110, but may be located at an external entity (e.g., phone company, cell phone carrier, etc.), who may keep track of the location of the mobile device 110. Any system, method, or technique for determining a location may be used.

In some implementations, the locator 112 may periodically determine the location of the mobile device 110. The rate or frequency with which the locator 112 may determine the location may vary depending on the type of mobile device 110 or the methods through which the locator 112 determines the location of the mobile device 110.

The locator 112 may store identifiers of locations in a local track storage 114. The identifier 112 may store the identifiers of location along with a temporal identifier of a time at which each identifier of a location is determined. In some implementations, the identifiers of location and temporal identifiers may be grouped together and stored as tracks. As described above, a track may be a group of identifiers of locations that represent a path taken by the mobile device 110. A track may have an identified beginning and end location. The beginning and ending location of a track may be determined by a user of the mobile device 110, or automatically by the mobile device 110 based on time lapses between detected mobile device 110 movements. For example, if the mobile device 110 has not moved from an identified location in an hour, the end of a track may be determined. As will be described further, the start and end location of a track may also be determined by a track application 118a or a track server 142, for example.

The environment 100 may further include a stationary device 130. The stationary device 130 may be similar to the mobile device 110, but may be lacking or may not have access to a locator 112. A user may use an application at the stationary device 130 that uses track information to view and organize tracks associated with the user, view tracks associated with other users, and perform various track related functions. The stationary device 130 may be implemented using a variety of computing devices including the computing device 1000 illustrated in FIG. 10, for example.

The mobile device 110 may further include a track client 116a. The track client 116a may control the operation of the locator 112 and the local storage 114, interface with a track application 118a executing on the mobile device 110, and connect to a server device 140 and/or the stationary device 130 though a network 120. The network 120 may be a variety of network types including the public switched telephone network (PSTN), a cellular telephone network, and a packet switched network (e.g., the Internet). The stationary device 130 may similarly include a track client 116b. The track client 116b may interface with a track application 118b executing on the stationary device 130 through the network 120.

The track client 116a may interface with the track application 118a through an application programming interface (API). The track application 118a may incorporate tracks and perform track operations using the API. Examples of track applications 118a may include an application that recommends tracks to a user based on the user's tracks and tracks of other users, applications that recommend stores to a user by identifying stores that are located near a track associated with the user, applications that recommend users to carpool based on tracks associated with the users, applications that provide driving directions, and applications that provide advertisements. Other types of applications may be used. By using an API with the track client 116a, a variety of applications 118a may perform track operations. Examples of track operations may include querying, clustering, and comparing tracks. The track client 116b and track application 118b may perform similar functions and operations with respect to the stationary device 130.

The track clients 116a and 116b may communicate with a track server application 142 executing on the server device 140. The server device 140 may be implemented on a variety of computing devices such as the computing device 1000 illustrated in FIG. 10, for example. As will be described further below, the track server application 142 may perform a variety of services and track related computations for the track clients 116a and 116b. Because the mobile device 110 may have limited storage and processing capabilities it may be desirable to perform such computations on the server device 140. However, there may be implementations where the mobile device 110 may perform some or all of the functions of the server device 140. Moreover, it is contemplated that multiple mobile devices may together perform the functions of the server device 140 in a peer-to-peer or other type of distributed computing arrangement.

The track server 142 may receive one or more tracks from the track client 116a. The track client 116a may periodically upload tracks determined at the mobile device 110. In some implementations, the tracks may have associated metadata. The metadata may be user generated or may be automatically generated. For example, the metadata may include a user generated description of the track such as “sightseeing” or “good shopping”. The metadata may also include images or photos generated by the user, videos generated by the user, and/or advertisements, for example. A user may generate the metadata using the track applications 118a or 118b, for example.

In some implementations, the track server 142 may receive location identifiers and temporal identifiers from a mobile device 110, rather than tracks. In these implementations, the track server 142 may generate tracks from the received location and temporal identifiers. Similarly as described above for the mobile device 110, the track server 142 may generate the tracks from the location identifiers by grouping the location identifiers with location identifiers that are temporally related.

In some implementations, the track application 118a may control the locator 112 and determine the particular location identifiers that constitute a track. For example, a track application 118a directed to helping users carpool may only activate the locator 112 in the morning and afternoon during typical commuting times, and may determine the start and end of a track based on a user's travels during those time periods. Similarly, an application 118a directed to running (e.g., jogging) may designate the beginning and ending of a track based on user input indicating that they are running, or when the mobile device 110 detects that the user is likely running.

The track server 142 may store the tracks in the global track storage 144. In some implementations, an entry for a track in the global track storage may include each location and temporal identifier associated with the track. In some implementations, users of the track applications 116a and 118a may also associate metadata with their tracks. The metadata may include a variety of data and data types. For example, the users may associate comments, videos, links, sounds, descriptions, notes, or any other type of data with a track. In addition, the track applications 118a and 118b may associate their own application specific metadata with the tracks. Metadata may also be associated with the location identifiers that make up the track rather than the entire track. The metadata may be stored along with the tracks in the global track storage 144.

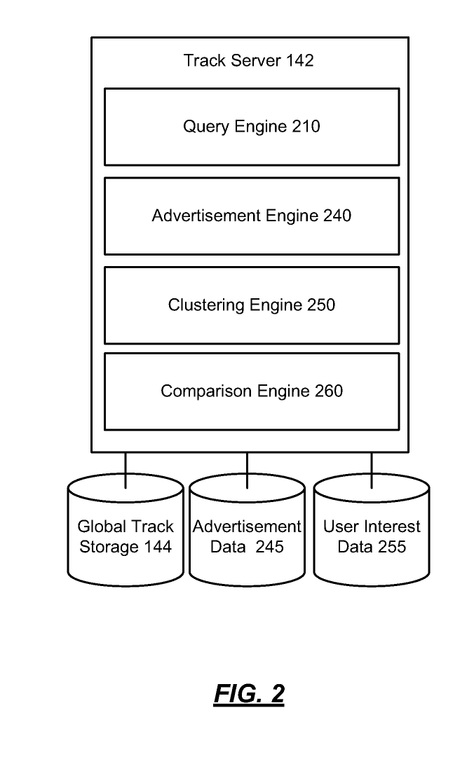

As will be described further with respect to FIG. 2 below for example, the track server 142 may provide various services and operations for the track clients 116a and 116b. In some implementations, the track server 142 may receive and respond to queries from the track clients 116a and 116b. For example, the track clients 116a and 116b may request identifiers of tracks having particular metadata or belonging to a particular user. In addition, the track server 142 may determine if a track is similar to another track, or may identify all tracks similar to a track specified by the track clients 116a and 116b. Other services may be provided by track server 142 such as providing advertisements targeted to a track, or identifying businesses near or proximate to a track. In addition, the track server 142 may control or enforce privacy settings on the track data. For example, a user may specify which users are able to view their tracks, and mark tracks as private. The track server 142 may consider such privacy settings when responding to queries. In addition, a user or application may specify one or more constraints for a query. The constraints may control the tracks that are returned in response to the query. For example, the constraints may specify a category of track, that a track be a subset or superset of a reference track, or that the tracks have a common beginning or ending location identifier. Other constraints may also be used.

FIG. 2 is a block diagram of an implementation of an example track server 142. As illustrated, in an implementation, the track server 142 includes several components including a query engine 210, an advertisement engine 240, a clustering engine 250, and a comparison engine 260. However, the track server 142 may support more or fewer components that those illustrated. The track server 142 may also access data including the global track storage 144 also illustrated in FIG. 1, advertisement data 245, and user interest data 255.

The clustering engine 250 may generate a “composite track” using two or more tracks associated with a user. For example, in order to compare users based on their associated tracks, it may be difficult to compare all the tracks associated with the users. Similarly, users typically take the same route or path over and over again leading to redundant paths stored in global track storage 144. Thus, a composite track may be generated for one or more users for purposes of comparison and to avoid redundant data in the global storage 144.

In some implementations, the composite track may be generated by clustering the location identifiers associated with each track using a clustering algorithm or other technique(s) such as k-means and k-median clustering. However, other clustering or averaging techniques may be used. The clustering engine 250 may store a composite track for a user in the global track storage 144, for example.

The clustered track may be a cluster of some or all tracks associated with a user for a particular time period. For example, to determine a track that represents a user's morning commute to work, the clustering engine 250 may generate a cluster track for the user tracks with time identifiers between 7 am and 9 am. In some implementations, the track server 142 may cluster the similar tracks into clusters. An example method used to identify similar tracks is discussed with respect to the comparison engine 260.

The comparison engine 260 may compare two or more tracks and determine whether the two tracks are similar tracks. For example, a track application 118a may determine users with similar tracks in order to make recommendations as to a carpool arrangement for the users. In order to perform such recommendations, the track application 118a or 118b, via the track client 116a or 116b, may request that the track server 142 identify users with similar tracks or compare two or more identified tracks.

In some implementations, the comparison engine 260 may return a binary value (e.g., 0 or 1) indicating whether or not two tracks are similar. In other implementations, the comparison engine 260 may return a percentage or score indicating the degree of similarity between two tracks.

What constitutes a similar track may vary depending on the needs or other aspects of the track applications 118a and 118b. For example, for some applications only tracks that share end points and/or start points may be considered similar. Other applications may only require that one of the two tracks be a subset of the other. For example, a track application 118a that is directed to carpooling may only require that a smaller track be a subset of a larger track so that at least one user could drive the other. Accordingly, the API exposed to the track applications 118a and 118b by the track clients 116a and 116b may support a variety of arguments that allow the applications to specify what they mean by similar and how they want their results based on the needs of the application.

In some implementations, the comparison engine 260 may compare the tracks by defining areas, such as circles, around each of the identified locations associated with a first track. The comparison engine 260 may then determine the percentage of, or number of, the identified locations associated with a second track that fall within the defined areas. If enough of the identified locations from the second track fall within the defined areas, then the first and second tracks may be similar tracks. The particular threshold percentage or number of identified locations that need to fall within the defined areas may be determined by an application, administrator, or other user and may depend on the degree of accuracy needed by a track application 118a or 118b. The size or radius of the defined areas may similarly be chosen or determined.

In some implementations, rather than being the same size, the size of each defined area may be dependent on, or a function of, the amount of distance between a current identified location and a previous identified location in a track. Because of variations in the frequency and performance of different types of locators 112 in mobile devices 110 such as GPS and cellular location, each track may have varied amounts of identified locations. This may result in a location identifier of a similar track that is outside of a defined area where two tracks have a disparity in location identifier density. To account for this, the size of a defined area around a current location identifier may be adjusted based on the amount of distance between it and a previous location identifier. In particular, the size of a defined area may grow as the distance between the current location identifier and a previous location identifier grows.

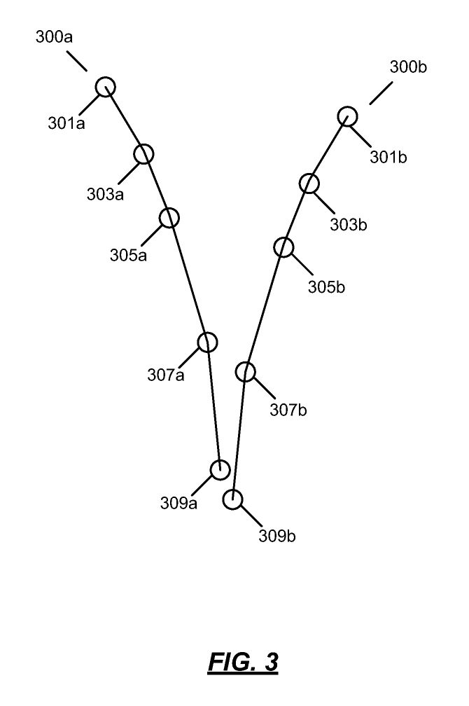

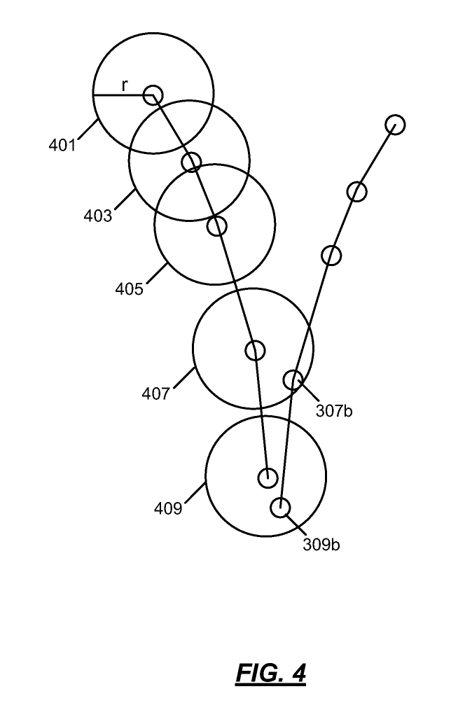

For example, consider the sample tracks 300a and 300b illustrated in FIG. 3. The track 300a includes location identifiers 301a-309a. The track 300b includes location identifiers 301b-309b. FIG. 4 is an illustration for an example process for determining similar tracks using defined areas, e.g., for comparing the track 300a with the track 300b using defined areas having static or fixed sizes. More specifically, circles of a fixed radius r have been defined around the location identifiers 301a, 303a, 305a, 307a, and 309a. These circles are illustrated in FIG. 4 as circles 401, 403, 405, 407, and 409 respectively. While the defined areas are shown as circles, it is for illustrative purposes only. Any type of shape or boundary may be used for the defined areas. For example, implementations may use rectangles rather than circles.

As illustrated in FIG. 4, two of the location identifiers of track 300b lie inside of the defined area. Location identifier 307b and location identifier 309b lie inside of circles 407 and 409, respectively. If, for example, 2 out of 5 is below the similarity threshold, the comparison engine 260 may determine that the tracks 300a and 300b are not similar (i.e., are dissimilar).

In other implementations, the comparison engine 260 may compare a first and a second track by defining a path of width w through the identified locations of the first track, and determining the percentage of identified locations of the second track that are within the defined path. Similarly to the method using defined areas described above, the size of w selected as well as the threshold value may determine the accuracy of the similarity comparison and may be specified by the track applications 118a or 118b, for example.

In some implementations, rather than a fixed width w, the size of w may be varied based on the distance between a current location identifier and a previous location identifier. To account for curves in the path, the value of w may be set to approximately the distance between the current location identifier and the previous location identifier, for example. Other methods may also be used to determine the size of w.

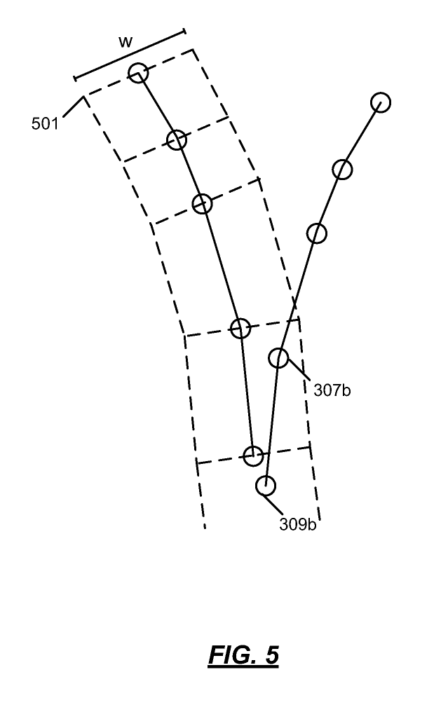

For example, again consider the sample tracks illustrated in FIG. 3. As shown in FIG. 5, a path 501 of fixed width w is defined through the track 300a. Two of the location identifiers of track 300b (i.e., 307b and 309b) lie inside of the defined path 501. Assuming again that 2 out of 5 is below the similarity threshold, the comparison engine 240 may determine that the tracks 300a and 300b are not similar.

The track server 142 may further include a query engine 210. The query engine 210 may receive queries from the mobile device 110 and the stationary device 130 via the track clients 116a and 116b, respectively. The query engine 210 may identify one or more tracks from the global track storage 144, and may present the identified one or more tracks or information related to the identified one or more tracks such as metadata, for example.

In an implementation, queries that may be received by the query engine 210 may comprise a request to identify similar tracks or to determine if a first track is similar to a second track. These types of queries may be provided to the comparison engine 260 for handling. The query engine 210 may receive results of a comparison or may receive identifiers of one or more tracks that match the request. The results and/or identifiers may be returned to the requesting user by the query engine 210.

Another type of request that may be received by the query engine 210 is to identify one or more tracks matching user specified keywords or constraints. For example, a user may request to view the tracks associated with hiking near their area. Accordingly, the query engine 210 may search for tracks from the global track storage 144 having tags or associated metadata that includes hiking. For example, a user may have added hiking to the metadata associated with a track using one of the track applications 118a or 118b. In addition, the query engine 210 may further refine the search by only searching tracks from the global track storage 144 having identified locations near the user or near tracks associated with the user.

In some implementations, the query engine 210 may further search or have access to user interest data 255. The user interest data 255 may include an entry for the users associated with the tracks from the global track storage 144. The user interest data 255 may include data that describes the interests and/or characteristics of the users. The user interest data 255 may be user generated, or may be generated automatically based on queries submitted by the user to the query engine 210 or other users that the user is friends with or associated with. In some implementations, the user interest data 255 may be extracted from one or more social networking applications. For example, the user interest data 255 may include information such as information describing a user's demographic information (e.g., marital status, hometown, occupation, age, residence, etc.), tastes (e.g., hobbies, favorite movies, favorite television shows, etc), and friends (e.g., identifiers of other users who a user is friends with or connected to).

The query engine 210 may fulfill queries from the user interest data 255. For example, a user may submit a query asking for one or more tracks that are representative of tracks submitted by one or more of their friends. The query engine 210 may then retrieve one or more composite tracks from the global track storage 144 associated with users who are friends with the user as identified by the user interest data 255. A user may also submit queries for tracks from users having similar interest, tastes, or occupations, for example, as evidenced by the user interest data 255.

The track server 142 may further include an advertisement engine 240. The advertisement engine 240 may identify relevant advertisements from advertisement data 245. In some implementations, the advertisement engine 240 may identify relevant advertisements in response to a request received by the query engine 210. The relevant advertisements may be identified based on keywords. For example, a user may submit a query for tracks related to tourism by submitting the query “tourist”. The advertisement engine 240 may then identify one or more advertisements related to tourism or advertisements from advertisers who have paid or will pay to have their advertisements displayed for the keyword “tourism”. One or more of the advertisements identified by the advertisement engine 240 may be returned with the results generated by the query engine 210 where they may be displayed by the track application 116a or 116b, for example.

In some implementations, the advertisement engine 240 may identify one or more advertisements from the advertisements based on one or more tracks. For example, an advertiser may want to target an advertisement for a particular restaurant to users when they view tracks that have location identifiers that are within a certain distance of the restaurant. Accordingly, when the query engine 210 returns such a track, the advertisement engine 240 may cause the corresponding advertisement to also be returned.

In some implementations, the advertisement engine 240 may further identify advertisements based on temporal indicators associated with the tracks. For example, based on the user tracks, the advertisement engine 240 may identify that the user goes to a particular coffee shop around 3 pm every weekday. Thus, the advertisement engine 240 may display an advertisement or recommend a competing coffee shop around 3 pm to the user recognizing that the user may be interested in coffee at that time.

In some implementations, the advertisement engine 240 may identify one or more advertisements 240 based on user interest data 255. For example, an advertiser may want an advertisement to be shown to users whose associated user interest data 255 evidences an interest in food. The advertisement engine 240 may further identify advertisements based on combinations of the query data, tracks, temporal indicators, and the user interest data 255. For example, an advertiser may specify that an advertisement for a restaurant be displayed for users whose user interest data evidences an interest in food and who typically dine out based on their locations during dinner time.

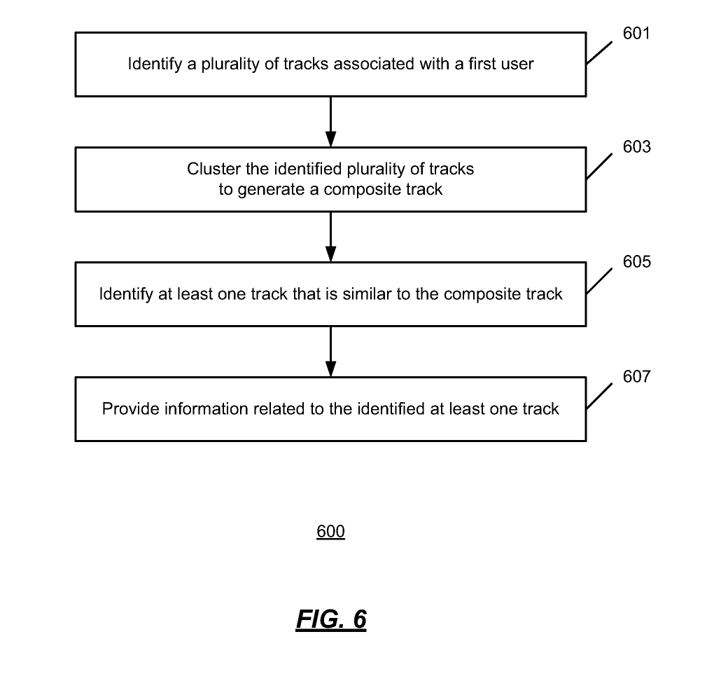

FIG. 6 is an operational flow of an implementation of a method 600 for identifying a similar track using a cluster and providing information related to the similar track. The method 600 may be performed by the track server 142, for example

A plurality of tracks associated with a first user is identified (601). The tracks may be identified by the track server 142 from the global track storage 144 using a user identifier associated with the first user. In some implementations, the identified plurality of tracks associated with the first user may further be associated with an identified time or time period. For example, the identified tracks may be tracks associated with the first user that occur on Saturday nights between 11 pm and 2 am, or on weekdays between 8 am and 10 am. In addition, metadata or tags may be used to identify the plurality of tracks. For example, the identified tracks may be tracks associated with the tag “nightlife” or “commute”.

The identified pluralities of tracks are clustered to generate a composite track for the first user (603). The identified tracks may be clustered by the clustering engine 250 of the track server 142, for example. In some implementations, the tracks may be clustered using k-means or k-median clustering. Other methods for clustering may also be used. By clustering user tracks, comparisons between users based on tracks may be made more easily because a single composite track may be used rather than several possibly redundant tracks.

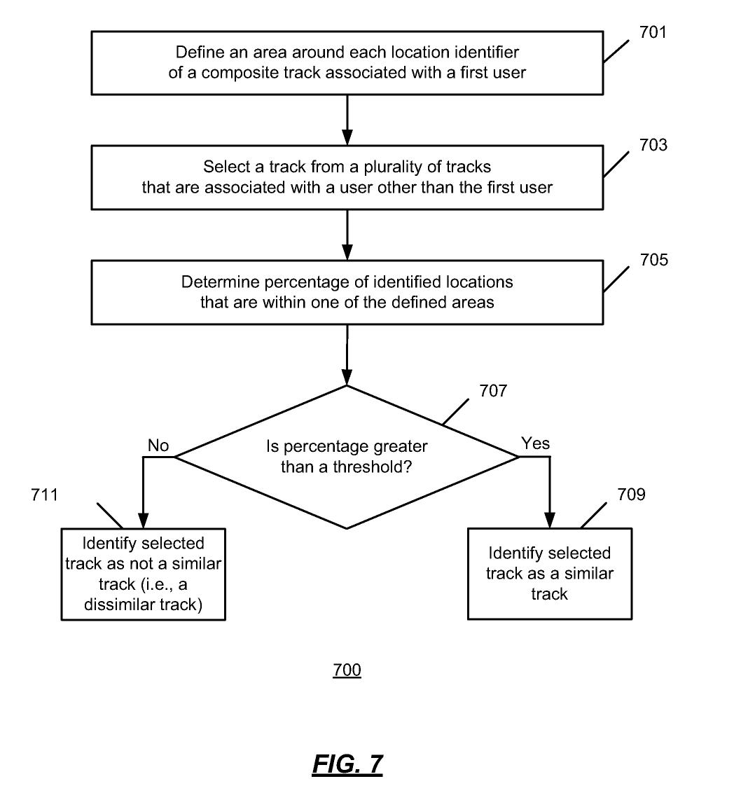

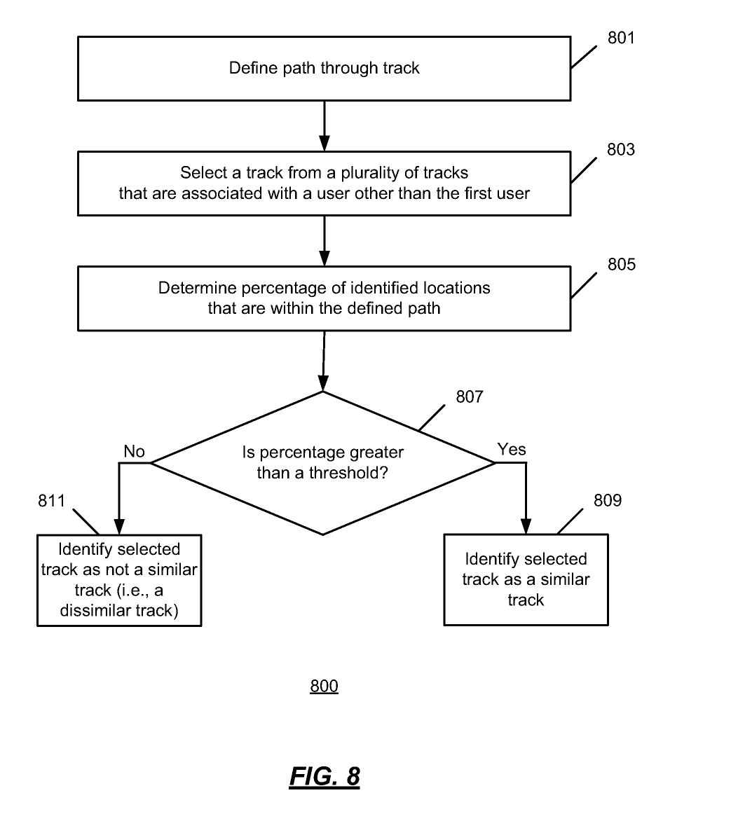

At least one track that is similar to the composite track is identified (605). The at least one similar track may be identified by the comparison engine 260 of the track server 142, for example. Some example methods for identifying a similar track are described further with respect to FIGS. 7 and 8.

Information related to the similar track may be provided (607). The information may be provided by the query engine 210 and/or the advertisement engine 240 of the track server 142. In some implementations, the information may be an identifier of the at least one track. In other implementations, the information may be some or all of the metadata associated with the track such as a user associated with the track or tags associated with the track. The information may further be one or more advertisements associated with the at least one track, or identifiers of business located near the at least one track, for example.

FIG. 7 is an operational flow of an implementation of a method 700 for identifying similar tracks using defined areas. The method 700 may be implemented by the comparison engine 260 of the track server 142, for example.

An area is defined around each location identifier of a composite track associated with a first user (701). The area may be defined by the comparison engine 260 of the track server 142. In some implementations, the defined areas may be circles; however, other shapes may be used. The size of each defined area may be fixed, or alternatively, the size of each defined area may change based on the distance between the location identifier it surrounds and a previous location identifier. For example, in an implementation where the defined areas are circles, the radius of each defined area may increase as the distance between a location identifier and a previous location identifier in the track increases.

A track from a plurality of tracks that are associated with a user other than the first user is selected (703). The track may be selected by the comparison engine 260 from the global track storage 144 for comparison with the composite track of the first user. Alternatively, the track may have been specified by the query engine 210 and/or the track applications 118a or 118b, for example.

The percentage of location identifiers of the selected track that are within one of the defined areas is determined (705). The determination may be made by the comparison engine 260.

The percentage may be compared to a threshold. In an implementation, a determination is made as whether the percentage is greater than a threshold percentage (707). The determination may be made by the comparison engine 260. If it is determined that the percentage is greater than the threshold percentage, then the selected track may be identified as similar track (709). Otherwise, the selected track is identified as not similar (i.e., dissimilar) (711). Alternatively, the comparison engine 260 may generate a score or percentage that describes the degree of similarity between the tracks.

FIG. 8 is an operational flow of an implementation of a method 800 for identifying similar tracks using a path. The method 800 may be implemented by the comparison engine 260 of the track server 142, for example.

A path is defined through each location identifier of a composite track associated with a first user (801). The path may be defined by the comparison engine 260 of the track server 142. In some implementations, the width of the path may be fixed or constant through each location identifier. In other implementations, the width of the path may vary at each location identifier. For example, the width of the track at each location identifier may change proportionally to the distance between the location identifier and a previous location identifier. In some implementations, the width may be set to approximately the distance between the location identifier and a previous location identifier, but other sizes may be used such as half the distance or twice the distance, for example.

A track from a plurality of tracks that are associated with a user other than the first user is selected (803). The track may be selected by the comparison engine 260 from the global track storage 144 for comparison with the composite track of the first user. Alternatively, the track may have been specified by the query engine 210 and/or the track applications 118a or 118b, for example.

The percentage of location identifiers of the selected track that are within the path is determined (805). The determination may be made by the comparison engine 260.

The percentage may be compared to a threshold. In an implementation, a determination is made as whether the percentage is greater than a threshold percentage (807). The determination may be made by the comparison engine 260. If it is determined that the percentage is greater than the threshold percentage, then the selected track may be identified as similar track (809). Otherwise the selected track is identified as not similar (811). Alternatively, the comparison engine 260 may generate a score or percentage that describes the degree of similarity between the tracks.

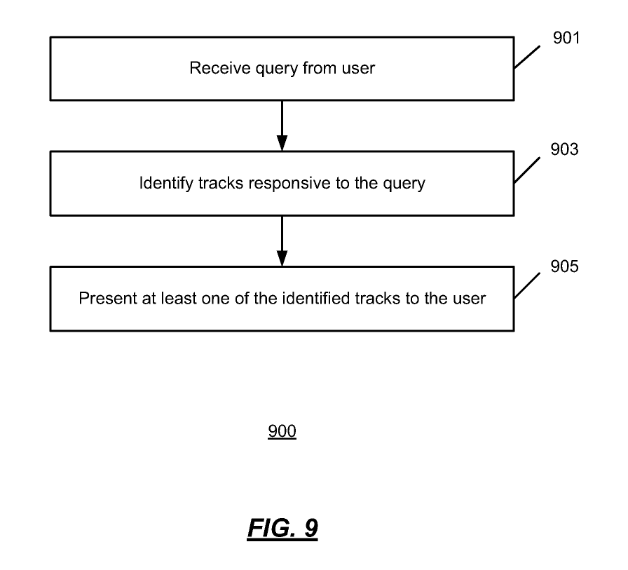

FIG. 9 is an operational flow of an implementation of a method 900 for identifying one or more tracks responsive to a query. The method 900 may be implemented by a query engine 210 of a track server 142, for example.

A query is received from a first user (901). The query may be received from a user at the query engine 210 of the track server 142. The query may include one or more terms that describe what the first user is looking for. For example, the query may be a request to identify one or more tracks that are similar to an identified track. The query may include one or more keywords and may be a request to identify one or more tracks or users associated with tracks that match the keywords. In some implementations, the query may further include a temporal identifier that describes a time constraint for the query. For example, the first user may request tracks associated with the keyword “lunch” and associated with times between 11 am and 2 pm.

One or more tracks that are responsive to the query are identified (903). The tracks may be identified by the query engine 210 from the track in the global track storage 144, for example. In some implementations, the one or more tracks may be identified by matching one or more keywords or temporal identifiers associated with the query. In addition, where no tracks are responsive to the query, no tracks may be identified. In other implementations, the one or more tracks may be further identified using a location identifier associated with the first user. For example, the first user may be located in Redmond, Wash. The query engine 210 may identify tracks that are in or proximate to Redmond, Wash., or more specifically the actual location of the first user in Redmond.

At least one of the identified tracks is presented to the first user (905). The at least one of the identified tracks may be presented by the query engine 210 of the track server 142. The tracks may be presented to the track application 118a or 118b associated with the first user that originated the query, for example.

FIG. 10 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 10, an exemplary system for implementing aspects described herein includes a computing device, such as computing device 1000. In its most basic configuration, computing device 1000 typically includes at least one processing unit 1002 and memory 1004. Depending on the exact configuration and type of computing device, memory 1004 may be volatile (such as random access memory (RAM)), non-volatile (such as read-only memory (ROM), flash memory, etc.), or some combination of the two. This most basic configuration is illustrated in FIG. 10 by dashed line 1006.

Computing device 1000 may have additional features/functionality. For example, computing device 1000 may include additional storage (removable and/or non-removable) including, but not limited to, magnetic or optical disks or tape. Such additional storage is illustrated in FIG. 10 by removable storage 1008 and non-removable storage 1010.

Computing device 1000 typically includes a variety of computer readable media. Computer readable media can be any available media that can be accessed by device 1000 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 1004, removable storage 1008, and non-removable storage 1010 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1000. Any such computer storage media may be part of computing device 1000.

Computing device 1000 may contain communications connection(s) 1012 that allow the device to communicate with other devices. Computing device 1000 may also have input device(s) 1014 such as a keyboard, mouse, pen, voice input device, touch input device, etc. Output device(s) 1016 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
storing a plurality of tracks, wherein each track comprises a plurality of location identifiers and temporal identifiers,
receiving a query from a user at a computing device through a network;
identifying one or more tracks that are responsive to the query by the computing device; and
presenting at least one of the identified tracks to the user through the network.

2. The method of claim 1, wherein designated location identifiers are specified as the start of the track and the end of each track.

3. The method of claim 1, wherein a track comprises a beginning of track location identifier and an end of track location identifier.

4. The method of claim 1, wherein a track has metadata associated with it.

5. The method of claim 4, wherein the metadata comprises one or more of advertisements, images, or indicators of businesses.

6. The method of claim 1, wherein a location identifier has metadata associated with it.

7. The method of claim 1, further comprising clustering tracks into a plurality of categories.

8. The method of claim 7, wherein the clustering comprises k-means clustering.

9. The method of claim 1, wherein the query is associated with one of a geographical region, metadata, a time interval, or a track.

10. A method comprising:
receiving a first track and a constraint at a computer device through a network;
identifying a second track that is responsive to the constraint and that is different from the first track at the computer device through the network; and
determining the similarity between the first and the second tracks.

11. The method of claim 10, wherein the constraint is one of that the first track is a subset or superset of the second track, that the first track and the second track have a same start location identifier, or that the first track and the second track have a same end location identifier.

12. The method of claim 10, wherein each track comprises a plurality of location identifiers and determining the similarity between the first and the second tracks comprises:
defining an area around each location identifier of the first track; and
determining a percentage of location identifiers of the second track that are within one of the defined areas.

13. The method of claim 12, wherein the defined areas are circles and defining an area around each location identifier comprises, for each location identifier of the first track:
determining a distance between the location identifier and a previous location identifier;
determining a radius for a defined area based on the determined distance; and
defining an area around the location identifier having the determined radius.

14. The method of claim 12, wherein the defined areas are rectangles and defining an area around each location identifier comprises, for each location identifier of the first track:
determining a distance between the location identifier and a previous location identifier; and
determining a width for the rectangle at the location identifier based on the determined distance.

15. The method of claim 14, wherein the width is based on a function of the determined distance.

16. A system comprising:
at least one server device that stores a plurality of tracks, each track comprising a plurality of location identifiers and associated with a user; and
a client device that executes an application, wherein the application:
records one or more tracks associated with the user based on one or more locations of the client device;
provides one or more tracks to the at least one server device for storage; and
performs one or more track operations on the stored plurality of tracks through an application programming interface.

17. The system of claim 16, wherein the track operations comprise querying, clustering, and comparing tracks.

18. The system of claim 16, wherein the plurality of location identifiers are global positioning system (GPS) coordinates.

19. The system of claim 16, wherein the application is one of a directions application, a carpooling application, or an advertising application.

20. The system of claim 16, wherein the application or server determines a beginning and an ending of generated tracks based on an amount of time that the client device is stationary or based on other application-specific criteria.
